(19) United States
(12) Patent Application Publication
(10) Pub. No.: US 2016/0138646 A1
(43) Pub. Date: May 19, 2016

(54) Ball Joint Connection

(71) Applicant: Hella KGaA Hueck & Co., Lippstadt (DE)

(72) Inventors: Thomas Elperman, Telgte (DE); Johannes Zywitzki, Everswinkel (DE)

(21) Appl. No.: 14/877,978

(22) Filed: Oct. 8, 2015

(30) Foreign Application Priority Data
Nov. 14, 2014 (DE) 102014116686.8

(51) Int. Cl. F16C 11/06

(52) U.S. Cl. CPC F16C 11/06

(57) ABSTRACT

A ball joint connection with a ball socket in which a ball segment-shaped opening is formed, and a joint ball is rotatably supported and snap-fitted in the ball socket. The joint ball shall be inserted in a ball socked with little effort, but can be removed only with a major effort or not at all in a nondestructive manner. To this end, below the opening, at least one rigid tab is fastened in the ball socket which, in a rest position, extends so far in the direction of the opening that it has a predetermined distance to the mounted joint ball. The tab is spring-elastically movable from the rest position during the assembly of the joint ball.

### CROSS REFERENCE

This application claims priority to German Application No. 10 2014 116686.8, filed Nov. 14, 2014, the entirety of which is hereby incorporated by reference.

### FIELD OF TECHNOLOGY

The invention relates to a ball joint connection with a ball socket in which a ball segment-shaped opening is formed, and a joint ball being rotatably supported and snap-fitted in the ball socket.

### BACKGROUND

In principle, such ball joint connections are known and they are generally used e.g. for the mechanical transmission of forces in a connection between a rod and a moving part. In automotive engineering, ball joint connections are e.g. known in connection with a coupling rod being arranged for the connection between a car body and a sensor, e.g. to determine a level (deflection) and/ or an inclination angle.

From DE 295 06 202 U1, a ball joint connection is known, which is made from a ball socket and a joint ball. The ball socket is manufactured separately from a rod carrying it and has a shaft which is inserted in the rod and pressed together with it.

EP 836 019 B1 shows a ball joint connection in which a joint ball is snap-fitted in a ball socket. A protective lip is provided which can deflect into a ring room under load.

### SUMMARY OF THE INVENTION

It is the task of the invention to improve a ball joint connection so that a joint ball can be inserted in a ball socked with little effort, but can be removed only with a major effort or not at all.

Below the opening, the ball socket has at least one rigid tab arranged, which reaches in a rest position so far in the direction of the opening, i.e. in the direction of the ball-segment-shaped region, that it shows a predetermined (specified) distance to the mounted joint ball, wherein the tab can be spring-elastically moved from the rest position during the assembly of the joint ball. When trying to separate the joint ball and the ball socket, the joint ball touches on end of the tab and applies load to it in parallel to its surface. The tab is then approximately vertical relative to the joint ball in the contact region. As the tab shows a predetermined stiffness—especially because of its dimensions in combination with the material properties relating to forces applied in parallel to its surface—it is impossible or very difficult for the tab to yield to the joint ball when an attempt is made to pull it out of the ball socket, so that the joint ball is held safely in the ball socket. The separation of ball socket and joint ball is only possible by destroying the tab and/or at least one of the components of the ball joint connection. The predetermined distance of the tab relative to the joint ball results in an unimpaired function of the ball joint connection, as the joint ball is snap-fitted with no or minimal play and therefore the tab does not touch the joint ball in normal operation. As the tab can be elastically moved during assembly, the required forces are low.

In one embodiment, two tabs are arranged opposite each other. By this means, the load applied by the tabs is symmetrical, so that the assembly of the ball head is facilitated.

In a further embodiment an angle α between a plane across the outer region of the opening and the tab is between 45° and 70°. Any try to pull the joint ball out of the ball socket reduces a bending moment acting upon the tab. Therefore, pulling out is only possible via destruction of the ball joint connection.

In a further embodiment, the ball socket has a recess in the region of the tab. By this means, the tab can yield into this recess, thus minimizing the required assembly forces.

In a further embodiment the (at least one) tab is embodied on a ring. By this means, it is possible to make the tab (including the ring) from a stronger, more rigid material than the ball socket. This is especially advantageous if the ball socket is made from a plastic material. The materials for the ball socket and for the tab can always be selected optimally. The ring with the tab(s) is particularly made in one piece.

In a further embodiment, the tab is made from spring steel sheet. Spring steel sheet provides, on one hand, good stiffness and on the other hand, the required elasticity.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a vertical section through a ball joint connection.

FIG. 2 shows a perspective view of the ball joint connection.

FIG. 3 shows a perspective view of a ring with tabs.

FIG. 4 shows a section through the ring.

### DETAILED DESCRIPTION OF THE DRAWINGS

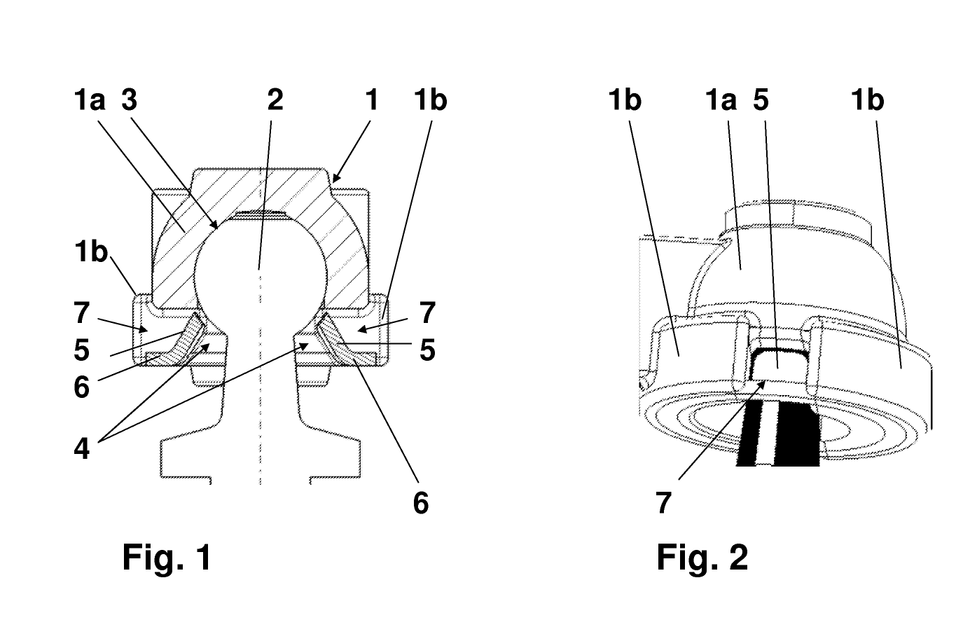

As can be seen in FIGS. 1 and 2, a ball joint connection comprises a ball socket 1 and a joint ball 2.

The ball socket 1 has a head piece 1a with a recessed ball segment-shaped opening 3. A plane cut surface of the ball segment forms an opening open toward the outside for the joint ball 2. In the region of the cut surface, a reinforcing ring 1b is molded onto the head piece 1a and encloses a frustrum-shaped open space 4, which abuts to the cut surface and widens toward the outside. Therefore, the opening 3 and the free space 4 form a unit.

A coupling rod, which is not represented, being fastened or linked to an assigned device on its end pointing away from the ball socket 1, is attached to the ball socket 1.

The entire ball socket 1 comprising the head piece 1a and the reinforcing ring 1b is integrally formed, e.g. made from injection-molded plastic material. Preferentially, the coupling rod with the ball socket 1 and the fastening or the linking means are integrally formed.

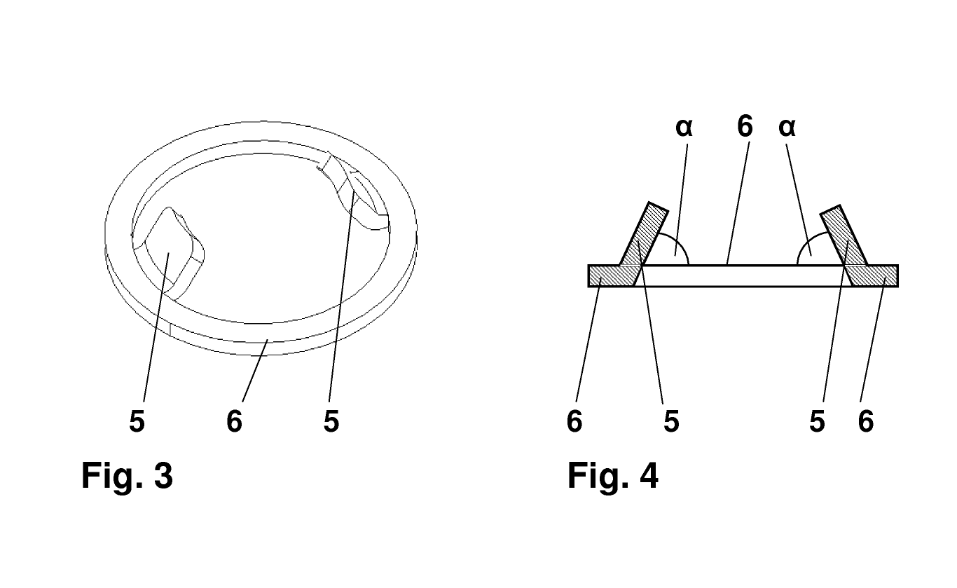

In the ball socket 1, below the opening 3, at least one spring-elastic tab 5 is arranged, which is largely rigid in parallel to its main surfaces. According to an embodiment, two approximately rectangular tabs 5 are embodied on a ring 6, which is represented in more detail in the FIGS. 3 and 4. Each of the tabs 5 extends from an inner edge of the ring 6 in the direction of a center axis of the ring 6 so that on one hand a projection of an axis of symmetry of the tab 5 is radially aligned and on the other hand an obtuse angle (180°—α) is formed between the tab 5 and a plane of the ring 6. The tab 5 is curved at least in a region remote from the ring 6 according to the radius of the ring 6. An edge of the tab 5 pointing away from the ring 6 is rounded in a concave manner and beveled according to the joint ball 2. The acute angle α between a plane of the ring 6 and the tab 5 is 45° to 70°. The axes of the tabs 5 are arranged offset by 180° on the ring.

The ring 6 with the tabs 5 is integrally formed from spring-elastic material and it is fastened around the free space 4 on the free end of the reinforcing ring 1b so that the tabs 5 point in the direction of the opening 3.

Alternatively, the ring 6 with the tabs 5 or only the tabs 5 together with the ball socket 1 are manufactured from spring-elastic material e.g. by means of two-component injection-molding.

In the region of the tabs 5, a recess 7 each is added to the reinforcing ring 1b, into which the assigned tab 5 can radially yield spring-elastically toward the outside, with regard to the opening 3 or the free space 4. Here, the recess 7 is continued toward the outside.

The joint ball 2 is integrally formed onto a head-end of a machine bolt. A diameter of the joint ball 2 essentially corresponds to that of the opening 3, so that between the ball socket 1 and the joint ball 2 there is no or only very little play. The joint ball 2 is e.g. made from metal.

The ball joint connection is manufactured as follows:

The joint ball 2 is integrally formed from metal or plastic material together with the machine bolt in the known manner. The ball socket 1 is manufactured together with the coupling rod in an injection molding process. Herein, the ring 6 being inserted in the injection mold accordingly, is molded in at the free end of the reinforcing ring 1b so that the tabs 5 are free. Optionally, the ball socket 1, together with the coupling rod and the tabs 5 and/or the ring 6 is manufactured in a two-component injection molding process. In another version, the coupling rod is manufactured separately and fastened to the ball socket.

The assembly of the ball joint connection is executed as follows:

A defined amount of lubricant, e.g. grease, is filled into the opening. The joint ball 2 is screw-fastened to a device, e.g. to a specified position of a vehicle body of a motor vehicle. The ball socket 1 is pressed onto the joint ball 2, resulting in the snap-fit of the two parts. Herein the tabs 5 are pressed from a rest position predetermined by production into the recesses 7 to subsequently spring back elastically into the rest position. A required press-in force is 50N to 60N. A clearance between the tabs 5 and the joint ball 2 is approximately 0.5 to 1 mm. Now the ball joint connection is assembly is completed.

A disassembly of the ball joint connection is essentially not possible without its destruction, as the tabs 5 prevent that the joint ball 2 is pulled out of the ball socket 1.

### LIST OF REFERENCE SIGNS

1 Ball socket

2 Head piece

3 Reinforcing ring

4 Free space

5 Tab

6 Ring

7 Recess

1. A ball joint connection comprising:
a ball socket in which a ball segment-shaped opening is formed,
a joint ball rotatably supported and snap-fitted in the ball socket, and
at least one rigid tab fastened in the ball socket below the opening
wherein in a rest position, the at least one rigid tab extends in the direction of the opening such that it has a predetermined distance to the mounted joint ball,
wherein the tab is spring-elastically movable from the rest position during the assembly of the joint ball.

2. The ball joint connection according to claim 1, wherein two tabs are arranged opposite each other.

3. The ball joint connection according to claim 1 wherein an angle (α) between a plane across an outer region of the opening and the tab is 45° to 70°.

4. The ball joint connection according to claim 1 wherein a recess is provided in the ball socket in the region of the tab.

5. The ball joint connection according to claim 1 wherein the tab is embodied on a ring c.

6. The ball joint connection according to claim 1 wherein the tab is made from spring steel sheet.
